(19) United States
(12) Patent Application Publication
(10) Pub. No.: US 2010/0197827 A1
(43) Pub. Date: Aug. 5, 2010

(54) Method of Manufacturing Polycarbonate/Polyester Resin Composition and Composition Manufactured Therefrom

(75) Inventors: Kyoung Tae Kim, Uiwang-si (KR); Chang Min Hong, Uiwang-si (KR); In Sik Shim, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/671,277

(22) PCT Filed: Dec. 31, 2007
(86) PCT No.: PCT/KR2007/007009

§ 371 Date: Jan. 29, 2010

(30) Foreign Application Priority Data
Aug. 1, 2007 (KR) 10-2007-0077512

(51) Int. Cl. C08J 3/22; C08L 69/00; C08K 5/20; C08K 3/38; C08K 3/08

(52) U.S. Cl. 523/351; 524/537; 524/226; 524/80; 524/439

(57) ABSTRACT

A method for preparing a polycarbonate/polyester alloy resin composition having excellent rigidity (flexural strength) and impact resistance strength is disclosed. The method includes adding a long fiber filler to a polyester resin to form a master batch, and blending the master batch and a polycarbonate resin. A polycarbonate/polyester alloy resin composition prepared by the method exhibits high rigidity and impact strength. Thus, the resin composition can be effectively used in the production of various molded articles such as mobile communication equipment, electric and electronic parts, and the like.

### TECHNICAL FIELD

The present invention relates to a method for preparing a polycarbonate/polyester resin composition having excellent rigidity (flexural strength) and impact resistance strength.

### BACKGROUND ART

Alloys of a polyester resin with a polycarbonate resin maintain excellent impact resistance of the polycarbonate and have improved chemical durability due to the polyester resin, and thereby exhibit excellent overall physical properties. Polycarbonate/polyester alloy resins have been used as parts of electronic products and vehicles because of their excellent chemical durability and high impact strength.

However, polycarbonate/polyester resin has low rigidity (flexural strength). Thus, there have been many limitations using polycarbonate/polyester resin in thin wall injection molding that is recently being widely used.

This problem may be resolved by combining a filler substance such as glass fibers with the polycarbonate/polyester alloy resin. Combining enriched fibers with a resin product obtained by polymerization may improve tensile strength, creep, fatigue resistance strength, and resistance to thermal expansion, in addition to rigidity.

However, there is a problem that despite the improvement in the above-mentioned physical properties, the impact resistance strength, which is an advantage of the polycarbonate resin composition, is seriously deteriorated.

One proposal to solve the problem is substituting a whole or a partial amount of the glass fibers with milled glass fibers. Although using the milled glass fibers improves impact strength, its effect is insignificant. Moreover, this method can be problematic because it is accompanied by reduced improvement in rigidity.

Another proposal to solve the problem is supplementing the resin with a long fiber filler instead of a short fiber filler in the resin. This method can be problematic because it is very difficult to provide an effective long fiber due to high viscosity of the polycarbonate composition, which is a noncrystalline resin.

The present inventors have put great efforts into solving these problems, and as a result, they have found that adding long fibers to a polyester resin to form a master batch, and then blending with a polycarbonate resin can provide a polyester/polycarbonate resin composition having an excellent chemical durability and impact resistance strength while maintaining a high rigidity. Thus, the inventors have completed the present invention based on these findings.

### DISCLOSURE

### Technical Problem

Therefore, the present invention has been made in view of the above problems, and it is an object of the present invention to provide a method for preparing a polycarbonate/polyester alloy resin composition capable of improving rigidity without reducing impact resistance strength, a resin composition prepared according to the method, and a mold produced from the composition.

The present invention is not limited to the above-mentioned objects, and other objects will be apparent and understood from the following description of the present invention by those skilled in the art to which the present invention pertains.

### Technical Solution

In accordance with an aspect of the present invention, the above and other objects can be accomplished by the provision of a method for preparing a polycarbonate/polyester alloy resin composition comprising: adding a long fiber filler to a polyester resin to form a master batch, and blending the master batch with a polycarbonate resin.

In accordance with another aspect of the present invention, there is provided a polycarbonate/polyester alloy resin composition prepared according to the preparation method.

In accordance with yet another aspect of the present invention, there is provided a plastic mold produced using the polycarbonate/polyester alloy resin composition.

Hereinbelow, the present invention will be described in greater detail. First, constituent components forming the resin composition of the present invention are examined.

(A) Polyester Resin

A polyester resin suitable for utilization in the present invention is represented by the following Formula 1, and its preparation method is similar to a typical polyester preparation method.

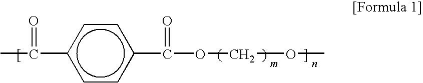

wherein, m is an integer of 2 to 4, and n is an integer of 50 to 300.

A preferred embodiment of a preparation method is as following. First, an acid compound, a glycol compound, and additives such as a catalyst and various stabilizers were charged to a stainless reactor equipped with a stirrer. While maintaining the temperature of the reaction tube at 200 to 230° C., an esterification reaction was carried out while removing low molecular ester condensation byproducts from the reactor at the same time. When the conversion rate of this esterification reaction is such that 95% or more of the theoretical discharge of the low molecular ester byproducts were discharged, the reaction was terminated. After the completion of the esterification reaction, the temperature inside the tube was elevated to 250 to 280° C., and the pressure was reduced to 1 mmHg or less to induce condensation polymerization of polyester. After the condensation polymerization, the reaction was terminated at an appropriate stirring load. Then, the system was vented with nitrogen, and the reactants were discharged to obtain a polyester resin suitable for the present invention.

Terephthalic acid or a lower alkyl ester thereof alone or in a combination with a small amount of isophthalic acid, orthophthalic acid, aliphatic dicarboxylic acid, or a lower alkyl ester thereof can be used as the acid compound in the process for preparing the polyester resin.

Ethylene glycol, propylene glycol, or butylenes glycol alone or in a combination thereof, or in a combination with a small amount of 1,6-hexanediol, 1,4-cyclohexanedimethanol or the like can be used as the glycol compound.

Antimony oxides, or organotitanium compounds such as tetrabutyltitanate or tetraisopropyltitanate can be used as the catalyst. However, an organotin compound alone or a combination with an organotitanium compound can also be used. Further, alkaline metals or acetates can also be used as the catalyst. When using an organotitanium compound as the catalyst, magnesium acetate or lithium acetate can be used as a co-catalyst.

The polyester resin suitable for the present invention includes a polybutylene terephthalate base resin. The polybutylene terephthalate base resin, for example, can be made of polybutylene terephthalate obtained by condensation-polymerization of 1,4-butanediol and terephthalic acid or dimethyl terephthalate through a direct esterification reaction or an ester exchange reaction. Other examples of the polybutylene terephthalate base resin include a copolymer of polybutylene terephthalate and polytetramethylene glycol (PTMG), polyethylene glycol (PEG), polypropylene glycol (PPG), low molecular aliphatic polyester or aliphatic polyamide, or a combination thereof. These impact resistant substances are copolymerized or mixed with the polybutylene terephthalate to further increase the impact strength of the polybutylene terephthalate base resin. In addition, it is preferable that the polybutylene terephthalate base resin has an intrinsic viscosity [η] in a range of 0.36 to 1.6 in presence of o-chlorophenol solvent at 25° C. When the intrinsic viscosity [η] is in the range of 0.36 to 1.6, the mechanical properties and moldability of the thermoplastic resin is more superior.

The polycarbonate/polyester alloy resin composition of the present invention comprising a polyester resin, a long fiber filler, and a polycarbonate resin may contain 20 to 70 parts by weight of polyester resin based on the total 100 parts by weight of polyester resin and polycarbonate resin.

Within the above content range, the polycarbonate/polyester alloy resin composition has reduced deterioration of fatigue resistance strength generated by the discontinuous structure in the polycarbonate resin, and has excellent physical property balance of chemical resistance and impact resistance strength.

(B) Polycarbonate Resin

An aromatic polycarbonate resin, which is another constituent component of the resin composition of the present invention, may be prepared by reacting diphenols represented by the following Formula 2 with phosgene, halogen formate or carboxylic acid diester.

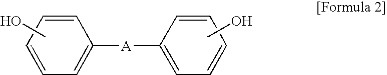

wherein, A is a single bond, C1-C5 alkylene, C1-C5 alkylidene, C5-C6 cycloalkylidene, —S—, or —SO2-.

Specific examples of the diphenols include 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, or the like. Among these, 2,2-bis-(4-hydroxyphenyl)-propane, 2,2-bis-(3,5-dichloro-4-hydroxyphenyl)-propane, and 1,1-bis-(4-hydroxyphenyl)-cyclohexane are preferable. Industrially, the most frequently used aromatic polycarbonate is prepared from 2,2-bis-(4-hydroxyphenyl)-propane, also called bisphenol-A, which is more preferably used.

A polycarbonate resin having a branched chain may be used as the polycarbonate resin in preparing the resin composition of the present invention. Preferably, 0.05 to 2 mol % of a trivalent, or more, i.e., polyvalent, compound, for example, a trivalent, or more, phenol group, based on the total amount of diphenols used in the polymerization is added to prepare the resin composition of the present invention.

In preparing the resin composition of the present invention, the polycarbonate resin may be used in a form of homo-polycarbonate or co-polycarbonate alone or in a blend of co-polycarbonate and homo-polycarbonate.

Meanwhile, it is also possible to substitute the whole or partial amount of the polycarbonate resin with an aromatic polyester-carbonate resin obtained by the polymerization in presence of an ester precursor, for example, a bivalent carboxylic acid.

It is preferable that the polycarbonate resin used in the preparation of the resin composition of the present invention has a weight average molecular weight of 20,000 to 50,000 g/mol. When the polycarbonate resin in the above range is utilized, the final resin composition is easily injectable and has excellent mechanical properties.

Moreover, it is preferable that the resin composition of the present invention contains the polycarbonate resin in an amount of 30 to 80 parts by weight based on 100 parts by weight of total amount of the polyester resin and polycarbonate resin. In this content range, the resin composition has excellent physical property balance of fatigue resistance strength, chemical resistance and impact resistance.

(C) Long Fiber Filler

Examples of a long fiber filler used as a filler for improving rigidity of the resin composition of the present invention include long glass fibers, long carbon fibers, long basalt fibers, long metal fibers, long boron fibers, long aramid fibers, long natural fibers, or the like. They may be used alone or in a combination according to the physical properties of the final product.

It is preferable that the polycarbonate/polyester alloy resin composition of the present invention contains the long fiber filler in an amount of 10 to 70 parts by weight based on 100 parts by weight of the total amount of the polyester resin, long fiber filler and polycarbonate resin. In this content range, the moldability is good and the rigidity is effectively enhanced.

The process for preparing the resin composition of the present invention includes forming a master batch of long fiber filler with the polyester resin. The long fiber filler used in the master batch has a length of 5 to 30 mm and the master batch is used in the dry blending process with the polycarbonate resin. The long fiber filler in this range of 5 to 30 mm has excellent enhancing effect of rigidity and impact resistance strength in the resin. In addition, there is less fear of generating problems when the long fiber filler with a length in this range is used in production.

Meanwhile, the polycarbonate/polyester resin composition of the present invention may use additives such as talc, silica, mica, alumina, or the like. When such an inorganic filler is added, physical properties such as the mechanical strength and the heat defection temperature can be improved. In addition, the resin composition of the present invention may further include a UV stabilizer, a heat stabilizer, an antioxidant, a flame retardant, a lubricant, a colorant and/or pigment. The use amount or method of these additives is widely known to a person of ordinary skill in the art.

In accordance with another aspect of the present invention, there is provided a method for preparing a polycarbonate/polyester alloy resin composition comprising: adding a long fiber filler to a polyester resin to form a master batch, and blending the master batch and a polycarbonate resin.

In the preparation method of the polycarbonate/polyester resin composition with enriched long fibers of the present invention, a glass roving machine using a plurality of specially prepared multi-fiber strands is used to fill the resin with the long fiber filler.

The conventional fiber filling method is usually carried out by adding the filler having a length of 3 to 5 mm through the same extruder hopper used to add the resin mixture for the preparation or by adding the filler through a different hopper from the resin mixture. On the other hand, the glass roving machine using a plurality of specially prepared multi-fiber strands fills the filler in a form of roving fiber by continuously immersing the filler in a melted resin mixture. The length of the fiber filled at this time can be prepared according to the length of the roving, if necessary, to approximately unlimited range, depending on the viscosity of the melted resin mixture.

It is preferable that the master batch prepared using the glass roving machine is prepared into a pellet having a fiber length of 5 to 30 mm, and more preferably 10 to 15 mm. The master batch in this range of 5 to 30 mm has excellent enhancing effect of rigidity and impact resistance strength in the resin. In addition, there is less fear of generating problems when the master batch in this range is used in production.

When the prepared master batch is dry blended with the polycarbonate resin, the resin composition of the present invention with improved impact resistance strength and rigidity can be obtained.

Therefore, since the method for preparing the polycarbonate/polyester alloy resin composition of the present invention can improve rigidity and impact resistance strength in the resin by effectively filling the long glass fibers, the resin composition can be effectively used in the production of various molded products such as mobile communication equipment, electric and electronic parts, and the like, which require the above-mentioned characteristics.

### ADVANTAGEOUS EFFECTS

As can be seen from the above, the polycarbonate/polyester alloy resin composition with enriched long fibers of the present invention has high rigidity and impact strength. Thus, the resin composition can be effectively used in the production of various molded products such as mobile communication equipment, electric and electronic parts, and the like, which require the above-mentioned characteristics.

### BEST MODE

Hereinafter, the components and functions of the present invention will be described in greater detail by way of appropriate Examples of the present invention, but these Examples are not intended to limit the present invention in any way. The contents, which are not described herein, are technically analogized by those skilled in the art to which the present invention pertains without difficulty, and therefore, a description thereof will be omitted.

Detailed specification of the constituent components used in Examples and Comparative Examples of the present invention are as follows.

(A) Polyester Resin

Polybutylene terephthalate TRIBIT 1700 available from Samyang Corp. having a specific gravity of 1.31 g/cm³, a melting point of 226° C., and an intrinsic viscosity of 1.1 was used as the polyester resin.

(B) Polycarbonate Resin

A bisphenol-A type polycarbonate having a weight average molecular weight of 25,000 to 27,000 g/mol was used as the polycarbonate resin.

(C) Long Fiber Filler

SE-8380 available from Owens Corning Corp., USA was used as the long fiber filler in the Examples of the present invention.

### Examples 1 to 3

Using the above-mentioned constituent components, resin compositions of Examples 1 to 3 were prepared with the formulation (unit: wt %) of the Examples listed in following Table 1. The physical properties of the resin compositions are also listed in Table 1. Long glass fibers (SE-8380 available from Owens Corning Corp., USA) were added to a polyester resin using glass roving equipment, which uses a plurality of multi-fiber strands, to prepare long glass fiber-enriched polyester resin pellets having a final fiber length of 12 mm. The master batch was homogeneously mixed with a polycarbonate resin via a dry blending process. This mixture was injection molded in a 10 oz-injection machine at a molding temperature of 250 to 280° C. and a mold temperature of 60 to 90° C. to prepare test samples for physical properties evaluation. The measurements were performed on the prepared test samples for notch izod impact strength (⅛″) based on ASTM D256 and flexural strength based on ASTM D790. For the fatigue fracture test, a stress of 5000 psi for 5 times per second was repetitively applied to a tensile sample in the length direction of the sample, and the final repetition cycle of stress was counted at the time the fatigue fracture occurred.

### Comparative Examples 1 to 4

Using the above-mentioned constituent components, resin compositions of Comparative Examples were prepared with the formulation (unit: wt %) of the Comparative Examples listed in following Table 1. The physical properties of the resin compositions are also listed in Table 1. In Comparative Examples 1 to 3, short fibers having a length of 3 mm and a diameter of 12 μm were added to the polycarbonate resin and polyester resin of Comparative Examples 1 to 3. The resin composition was extruded in a twin screw extruder of L/D=35 and Y=45 mm under the extrusion conditions in which the fixed temperature was 250° C., the screw rotation speed was 200 rpm, the first vent pressure was about −600 mmHg, and the autosupply rate was 60 kg/h. The extruded strands were cooled in water, and then cut into pellets using a rotary cutter. In Comparative Example 4, the contents of the polyester resin, long fiber filler, and polycarbonate resin were maintained as in Example 2. However, the polyester resin and polycarbonate resin were mixed without the process of preparing a master-batch, and then pellets were prepared with a glass roving machine using a plurality of the multi-fiber strands.

The obtained pellets were dried with hot blast at 80° C. for about 3 hours, and injection molded in a 10 oz-injection machine at a molding temperature of 250 to 280° C., and a mold temperature of 60 to 90° C. to prepare samples for physical property evaluations. The measurements were performed on the prepared test samples for notch izod impact strength (⅛″) based on ASTM D256 and flexural strength based on ASTM D790.

TABLE 1
Soil Removal Performance of liquid abrasive cleansers

| | | | Example | | | Comparative Example | | | |
|---|---|---|---|---|---|---|---|---|---|
| | | | 1 | 2 | 3 | 1 | 2 | 3 | 4 |
| Formulation | Polyester | | 40% | 35% | 29% | 40% | 35% | 29% | 35% |
| | resin | | | | | | | | |
| | Fiber | Long | 20% | 30% | 40% | — | — | — | 30% |
| | | fiber | | | | | | | |
| | | Short | — | — | — | 20% | 30% | 40% | — |
| | | fiber | | | | | | | |

| | | | | | | | | |
|---|---|---|---|---|---|---|---|---|
| | Master-batch | 60% | 65% | 69% | — | — | — | — |
| | of polyester | | | | | | | |
| | resin and | | | | | | | |
| | long fiber | | | | | | | |
| | Polycarbonate | 40% | 35% | 31% | 40% | 35% | 31% | 35% |
| | resin | | | | | | | |
| Physical | Izod impact | 11.3 | 14.9 | 18.5 | 5.5 | 6.9 | 7.1 | 7.0 |
| properties | strength | | | | | | | |
| | (Kgf · cm/cm) | | | | | | | |
| | Flexural | 55,000 | 91,000 | 121,000 | 39,800 | 65,700 | 81,000 | 70,000 |
| | strength | | | | | | | |
| | (Kgf/cm²) | | | | | | | |
| | Stress repetition | 15,900 | 20,000 | 25,800 | 12,500 | 17,900 | 21,000 | 18,100 |
| | cycles at fatigue | | | | | | | |
| | fracture (cycle) | | | | | | | |

For the formulations and physical properties of Examples and Comparative Examples shown in Table 1, it can be seen that for the resin composition containing the same amount of polycarbonate and polyester resins, the resin compositions filled with long fibers (Examples 1 to 3) had great improvement in both impact strength and flexural strength as compared with the resin compositions filled with short fibers (Comparative Examples 1 to 3). Moreover, the resin compositions filled with long fibers showed improved impact strength and flexural strength as the content of the long fibers increased (Example 1→Example 3). The stress repetition cycles at the fatigue fracture increased as the content of the long fibers increased.

Meanwhile, the resin composition of Comparative Example 4 prepared by a simple extrusion method without the process of preparing a master-batch using the same formulation as the components in Example 2, could not obtain a great improvement in the physical properties compared with the case of resin compositions enriched with short fibers, because the resin immersion of the long fibers is reduced in the resin composition of Comparative Example 4.

Therefore, since the polycarbonate/polyester alloy resin composition disclosed in the present invention exhibits high rigidity and impact strength, the resin composition can be effectively used in the production of various molded articles such as mobile communication equipment, electric and electronic parts, and the like, which require those characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for preparing a polycarbonate/polyester alloy resin composition comprising:
adding a long fiber filler to a polyester resin to form a master batch; and
blending the master batch and a polycarbonate resin.

2. The method according to claim 1, wherein the step of forming a master batch is performed using a glass roving machine.

3. The method according to claim 1, wherein the master batch is formed into a pellet having a length of 5 to 30 mm.

4. The method according to claim 1, wherein the polyester resin is a polybutylene terephthalate polymer obtained by condensation-polymerization of 1,4-butanediol and terephthalic acid or dimethyl terephthalate through a direct esterification reaction or an ester exchange reaction.

5. The method according to claim 1, wherein the polyester resin comprises a copolymer of polybutylene terephthalate and polytetramethylene glycol (PTMG), polyethylene glycol (PEG), polypropylene glycol (PPG), aliphatic polyester or aliphatic polyamide, or a combination thereof.

6. The method according to claim 1, wherein the polyester resin has an intrinsic viscosity [η] in a range of 0.36 to 1.6 in presence of o-chlorophenol at 25° C.

7. The method according to claim 1, wherein the polycarbonate resin has a weight average molecular weight of 20,000 to 50,000 g/mol.

8. The method according to claim 1, wherein the polycarbonate resin is prepared by reacting diphenols represented by the following Formula 2 with phosgene, halogen formate or carboxylic acid diester 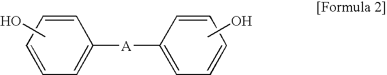
wherein A is a single bond, C1-C5 alkylene, C1-C5 alkylidene, C5-C6 cycloalkylidene, —S—, or SO₂—.

9. The method according to claim 1, wherein the long fiber filler comprises long glass fibers, long carbon fibers, long metal fibers, long aramid fibers, long boron fibers, long basalt fibers, long natural fibers, or a combination thereof.

10. A polycarbonate/polyester alloy resin composition prepared by the method according to claim 1.

11. The resin composition according to claim 10, comprising 10 to 70 parts by weight of a long fiber filler based on 100 parts by weight of the total amount of the polyester resin, long fiber filler, and polycarbonate resin.

12. The resin composition according to claim 10, comprising 20 to 70 parts by weight of a polyester resin and 30 to 80 parts by weight of a polycarbonate resin based on 100 parts by weight of the total amount of the polyester resin and polycarbonate resin.

13. The resin composition according to claim 10, wherein the long fiber filler comprises long glass fibers, long carbon fibers, long metal fibers, long aramid fibers, long boron fibers, long basalt fibers, long natural fibers, or a combination thereof.

14. A molded article produced from the resin composition according to claim 10.

15. The method according to claim 1, wherein the long fiber filler has a length of 5 to 30 mm.

16. The resin composition according to claim 10, wherein the long fiber filler has a length of 5 to 30 mm.

17. The molded article according to claim 14, wherein the long fiber filler has a length of 5 to 30 mm.
